(19) United States
(12) Patent Application Publication
(10) Pub. No.: US 2012/0087698 A1
(43) Pub. Date: Apr. 12, 2012

(54) DEVELOPER, DEVELOPMENT DEVICE, AND IMAGE FORMATION APPARATUS

(75) Inventor: Yuichi FURUKAWA, Tokyo (JP)

(73) Assignee: OKI DATA CORPORATION, Tokyo (JP)

(21) Appl. No.: 13/251,513

(22) Filed: Oct. 3, 2011

(30) Foreign Application Priority Data
Oct. 8, 2010 (JP) 2010-229127

(51) Int. Cl. G03G 15/08; G03G 9/08; G03G 9/16

(52) U.S. Cl. 399/252; 430/108.9; 430/108.23

(57) ABSTRACT

A developer includes a binder resin, a carbon black, and a black charge control agent. When an amount of the binder resin is 100 parts by weight, a blending quantity of the carbon black is set in a range of 3.0 to 7.0 parts by weight, both inclusive, and a blending quantity of the black charge control agent is set in a range of 0.3 to 1.2 parts by weight, both inclusive.

### CROSS REFERENCE TO RELATED APPLICATIONS

This application claims priority based on 35 USC 119 from prior Japanese Patent Application No. 2010-229127 filed on Oct. 8, 2010, entitled “DEVELOPER, DEVELOPMENT DEVICE, AND IMAGE FORMATION APPARATUS”, the entire contents of which are incorporated herein by reference.

### BACKGROUND OF THE INVENTION

1. Field of the Invention

The present disclosure relates to a developer and a development device that are used in an electrophotographic image formation apparatus such as an electrophotographic printer or photocopier. The present disclosure also relates to an image formation apparatus.

2. Description of Related Art

A conventional image formation apparatus includes a photosensitive drum, a development roller, a development blade, a supply roller, a charge roller, a toner cartridge, and the like. The toner supplied from the supply roller onto the development roller is formed into a uniform thin layer by using a development blade. Then, the toner on the development roller is adhered to the electrostatic latent image on the photosensitive drum, which is rotating while being in contact with the development roller. Then, a toner image thus formed is transferred to a sheet by using a transfer roller, and then is thermally fixed by a fuser. The toner used in the image formation apparatus has an average particle size of 8 μm and is manufactured as follows. A binder resin made of a styrene resin, a polyester resin or the like is kneaded with a colorant, a charge control agent and the like. Subsequently, the kneaded mixture is melted, then cooled, then pulverized, and then classified (see, for instance, Japanese Patent Application Publication No. 2003-295500, especially, see paragraphs [0016] to [0020] and [0037] to [0041], as well as FIG. 1).

### SUMMARY OF THE INVENTION

This process, however, makes it difficult to secure stable print density, and as a result, the print quality is likely to be deteriorated.

An object of an embodiment of the invention is to improve the image quality.

An aspect of the invention is a developer that includes a binder resin, a carbon black, and a black charge control agent. When an amount of the binder resin is 100 parts by weight, a blending quantity of the carbon black is set in a range of 3.0 parts by weight to 7.0 parts by weight, both inclusive, and a blending quantity of the black charge control agent is set in a range of 0.3 parts by weight to 1.2 parts by weight, both inclusive.

This aspect makes it possible to secure stable print density even when carbon black is used as a colorant.

### BRIEF DESCRIPTION OF THE DRAWINGS

FIG. 1 is an explanatory diagram schematically illustrating the configuration of a printer of Embodiment 1.

FIG. 2 is an explanatory diagram schematically illustrating the configuration around a development device of Embodiment 1.

FIG. 3 is a table showing the measurement results of the printing densities of Embodiment 1.

FIG. 4 is a table showing the results of judgment concerning the smearing of print of Embodiment 1.

FIG. 5 is a table showing the results of judgment concerning the drum fog of Embodiment 1.

FIG. 6 is a table showing the results of the overall evaluation concerning Embodiment 1.

FIG. 7 is a table showing the results of the overall evaluation concerning particle sizes of a toner of Embodiment 2.

FIG. 8 is a table showing the results of the overall evaluation concerning particle sizes of the other toner of Embodiment 2.

### DETAILED DESCRIPTION OF THE EMBODIMENTS

Descriptions are provided hereinbelow for embodiments based on the drawings. In the respective drawings referenced herein, the same components are designated by the same reference numerals and duplicate explanation concerning the same components is omitted. All of the drawings are provided to illustrate the respective examples only.

Descriptions are hereinbelow provided for a developer, a development device, and an image formation apparatus according to embodiments of the invention and with reference to the drawings.

### Embodiment 1

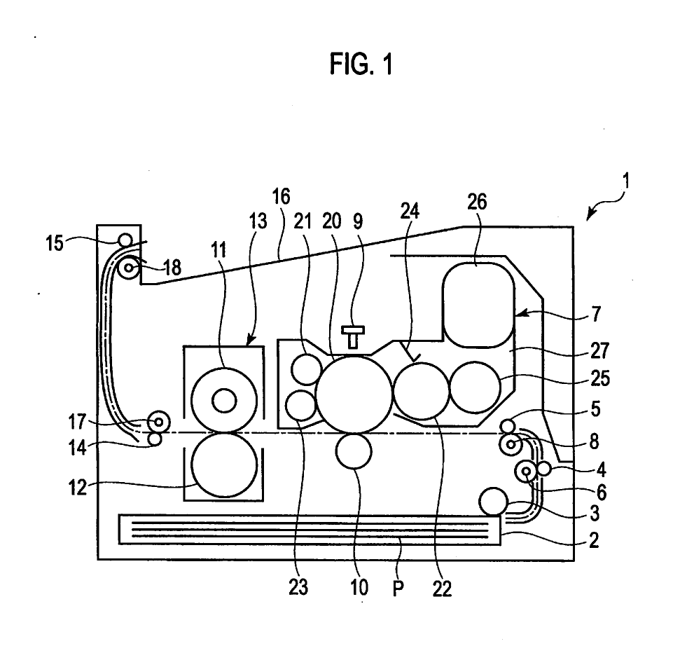

In FIG. 1, reference numeral 1 denotes a printer as an image formation apparatus. Printer 1 of Embodiment 1 is an electrophotographic monochrome printer configured to print images in black. As FIG. 1 shows, printer 1 is equipped with sheet cassette 2 (medium stocker) located in a lower portion of printer 1 and configured to stock a stack of paper sheets P as print media. Sheet cassette 2 is detachably installed in a lower portion of printer 1. Hopping roller 3 is provided over sheet cassette 2, and is configured to feed paper sheets P on a one-by-one basis by separating one paper sheet P from the others.

Pinch rollers 4, 5, transport roller 6, and register roller 8 are provided downstream of hopping roller 3 in the direction in which paper sheets P are transported (hereinafter referred to as a “sheet transport direction”). Transport roller 6 is configured to pinch paper sheet P in cooperation with pinch roller 4, and thereby to transport paper sheet P. Register roller 8 is configured to pinch paper sheet P in cooperation with pinching roller 5, and thereby to transport paper sheet P to development device 7 with the orientation of paper sheet P corrected if paper sheet P is transported obliquely. Hopping roller 3, transport roller 6, and register roller 8 are rotated by power transmitted via gears and the like from a drive source (not illustrated).

Exposure head 9 is provided over development device 7, and is configured to form an electrostatic latent image. Transfer roller 10 is provided under development device 7, and is configured to transfer a toner image, as a developer image formed by development device 7, onto paper sheet P. Fuser unit 13 is provided downstream of development device 7 in the sheet transport direction. Fuser unit 13 includes heat roller 11 and backup roller 12, and is configured to fix the transferred toner image to paper sheet P by applying pressure and heat to the toner image.

Discharge rollers 17, 18 and pinch rollers 14, 15 are provided downstream of fuser unit 13 in the sheet transport direction. Discharge rollers 17, 18 are configured to pinch paper sheet P, which is discharged from fuser unit 13, in cooperation with pinch rollers 14, 15 respectively, and thereby to transport paper sheet P to stacker 16 (medium stacker). Heat roller 11 of fuser unit 13, discharge rollers 17 and 18, and the like are rotated by power transmitted via gears and the like from the drive source (not illustrated). Incidentally, hopping roller 3, pinch rollers 4, 5, transport roller 6, register roller 8, pinch rollers 14, 15, and discharge rollers 17, 18 together constitute a medium transporter.

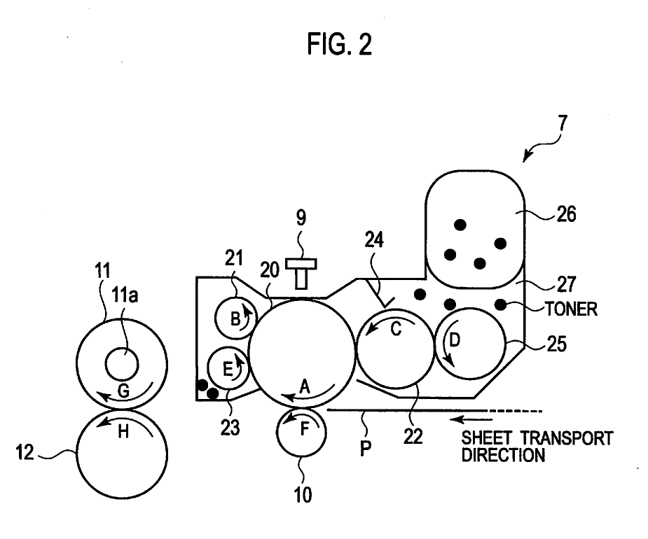

As FIG. 2 shows, development device 7 used in the development process in printer 1 of Embodiment 1 includes: photosensitive drum 20; charge roller 21, development roller 22, and cleaning roller 23 all of which are provided around photosensitive drum 20; development blade 24 and supply roller 25 both of which are provided around development roller 22; toner cartridge 26; toner chamber 27; and the like. Development device 7 is detachably installed in printer 1.

Photosensitive drum 20, which serves as a latent image carrier, is a cylindrical member in which a photoconductive layer is formed on the outer surface of a conductive pipe. The electrostatic latent image and the toner image, which is formed by developing the electrostatic latent image with the toner as the developer, are formed on the photoconductive layer. A drum gear is fixed to an end of photosensitive drum 20 by the press fitting method or another similar method. The drum gear is rotated by a drive power transmitted via a gear train from the drive source (not illustrated). Photosensitive drum 20 is driven to rotate in a rotary direction indicated by arrow A in FIG. 2 (referred to as “transport rotary direction A”), and rotates to transport paper sheet P in the sheet transport direction.

Exposure head 9, which serves as an exposure unit, is provided above, and opposed to, photosensitive drum 20.

Exposure head 9 includes multiple light emitting diodes (LEDs) as light emitting elements. In an exposure process, exposure head 9 casts light onto the surface of photosensitive drum 20, and thereby forms an electrostatic latent image on the surface layer of photosensitive drum 20. While in contact with photosensitive drum 20, charge roller 21, which serves as a charge unit, is rotated in a direction (direction B shown in FIG. 2) opposite to the direction in which the photosensitive drum 20 rotates, by receiving a drive power transmitted from the drum gear to a charge gear (not illustrated). Charge roller 21 uniformly charges the surface of photosensitive drum 20 at a surface potential with a charge voltage applied by a power source unit (not illustrated).

In addition, a conductive elastic layer is formed on charge roller 21. The conductive elastic layer is an ion-conductive rubber elastic layer mainly containing an epichlorohydrin rubber (ECO). The surface of the conductive elastic layer is processed by a surface treatment where a surface treatment liquid containing an isocyanate (HDI) content permeates and cures the surface of the conductive elastic layer. The surface treatment prevents photosensitive drum 20 from being contaminated, and eases the release of the toner, its external additive and the like. The conductive elastic layer has an Asker-C hardness of 73 which is measured with an Asker-C Durometer (manufactured by Kobunshi Keiki Co., Ltd.). Charge roller 21 has a resistance of 6.3 (log Ω).

The measurement of the resistance of charge roller 21 is conducted in the following way in an environment at a temperature of 20° C. and a humidity of 50%. In this environment, charge roller 21 is pressed against a conductive metal drum that has the same outer diameter and the same surface roughness as those of photosensitive drum 20. The pressure with which charge roller 21 is pressed against the conductive metal drum is equal to the pressure applied in printer 1. In addition, a 500V DC voltage is applied to the conductive metal drum.

While in contact with photosensitive drum 20, development roller 22, which serves as a developer carrier, is rotated in a direction (direction C shown in FIG. 2) opposite to the direction in which photosensitive drum 20 rotates, by a drive power transmitted from the drum gear to a development gear (not illustrated). Development roller 22 forms a toner image by making the toner adhere to the electrostatic latent image on photosensitive drum 20 with a development voltage applied by the power source unit (not illustrated).

Development roller 22 includes a semiconductor silicone-rubber layer, a surface coating layer and a silane coupling-agent layer. The semiconductor silicone-rubber layer is that which, as a UV-treated elastic body, is formed on a conductive shaft. The surface coating layer is made of a urethane resin, and is formed by applying the urethane resin to the surface of the semiconductor silicone-rubber layer.

The surface coating layer contains silica particles to form a certain surface roughness. The surface coating layer has the thickness of 7 μm to 13 μm. The surface coated with the surface coating is polished, if necessary, to have a surface roughness Rz of 3 μm to 12 μm (in accordance with JISB0601-1994). Note that a thicker surface roughness Rz within the above-mentioned range is desirable.

In addition, development roller 22 has a resistance R of 100 MΩ to 5000 MΩ, which is measured in the following way. A ball bearing made of stainless steel (SUS) with a 2.0 mm width and a 6.0 mm diameter is pressed against development roller 22 with a force of 20 gf, and a 100V voltage is applied between the ball bearing and the shaft. Then, the resistance R is calculated by dividing the voltage V by the current I (i.e., R=V/I). Here, it should be noted that the above expression “(numeral) to (numeral),” for example, “3 μm to 12 μm” indicates “a range of 3 μm to 12 μm, both inclusive.” The same shall apply in the other cases in this disclosure.

While pressed towards the rotary shaft of the development roller 22 by a distance (a nip amount) of 0.85 to 1.15 mm, supply roller 25, which serves as a developer supply unit, is rotated in the same direction (direction D shown in FIG. 2) as the direction in which development roller 22 rotates, by a drive power transmitted from the development gear to a supply gear (not illustrated). With a supply voltage applied by the power source unit (not illustrated), supply roller 25 supplies development roller 22 with the toner which is replenished to toner chamber 27, which serves as a developer chamber from toner cartridge 26, which serves as a developer stocker.

In addition, supply roller 25 is obtained by polishing foamed semiconductor silicone rubber, which is formed on a conductive shaft, so that supply roller 25 can have a predetermined outer diameter. The compound of the silicone rubber is made of various kinds of synthetic rubber, such as dimethyl silicone rubber and methylphenyl silicone rubber, with the addition of a reinforcement silica filler, a vulcanizing agent needed for vulcanization hardening, and a foaming agent. Either an inorganic foaming agent, such as sodium bicarbonate, or an organic foaming agent, such as ADCA (azodicarbon amide), is used as the foaming agent.

Supply roller 25 has an Asker-F hardness of 43 to 53, which is measured with an Asker-F Durometer (manufactured by Kobunshi Keiki Co., Ltd.). Supply roller 25 has a resistance R of 1 MΩ to 100 MΩ, which is measured in the same manner as is the resistance of development roller 22, but with a 300V voltage applied. Development blade 24, which serves as a developer-layer formation member, is provided in contact with the surface of development roller 22, and is configured to form a thin toner layer serving as a developer layer by thinly spreading the toner supplied by supply roller 25 onto development roller 22.

Cleaning roller 23, which serves as a cleaner unit, includes a conductive foam layer whose main material is EPDM (ethylene propylene diene rubber), and which is bonded to the outer periphery of the metal shaft of φ6 with a primer provided in between. While pressed against photosensitive drum 20 by biasing forces of spring members provided respectively on the two sides of the shaft, cleaning roller 23 is rotated in a direction (direction E shown in FIG. 2) opposite to the direction in which photosensitive drum 20 rotates, by a drive power transmitted from the drum gear to a cleaning gear (not illustrated). With either a positive voltage or a negative voltage applied to the shaft from the power source unit (not illustrated), cleaning roller 23 temporarily pools, in the conductive foam layer, the toner that remains on the surface of photosensitive drum 20 after the transferring of the toner image onto paper sheet P is finished. The pooled toner is discharged onto photosensitive drum 20 at a predetermined timing.

The conductive foam layer of cleaning roller 23 has an average foamed-cell size of 100 μm to 300 μm, which is measured by using a stereoscopic microscope. In addition, the conductive foam layer has an Asker-C hardness of 35 to 45, which is measured with an Asker-C Durometer (manufactured by Kobunshi Keiki Co., Ltd.) with a load of 4.9 N. Moreover, cleaning roller 23 has a resistance R of 2.0 MΩ to 20 MΩ, which is measured in the following way. A 400V voltage is applied to cleaning roller 23 being rotated while pressed in the rotary shaft direction of photosensitive drum 20 of φ30 by 0.25 mm Then, the resistance R is calculated by dividing the voltage V by the current I (i.e., R=V/I).

Transfer roller 10, which serves as a transfer unit, is provided under photosensitive drum 20, opposed to photosensitive drum 20 with paper sheet P, which is transported by a medium transport unit (not illustrated), interposed between transfer roller 10 and photosensitive drum 20. Transfer roller 10 is made of a conductive rubber, or the like. Transfer roller 10 is rotated in a direction (direction F shown in FIG. 2) opposite to the direction in which photosensitive drum 20 rotates, by a drive power transmitted from the drum gear to a transfer gear (not illustrated). Transfer roller 10 is configured to transfer the toner image, which is formed on photosensitive drum 20, onto paper sheet P by using the potential difference between the surface potential provided by the transfer voltage applied by the power source unit (not illustrated) and the surface potential of photosensitive drum 20.

Fuser unit 13, which serves as a fixing unit, is a unit configured to perform a fixing process, and is provided downstream, in the sheet transport direction, of both development device 7 configured to perform the development process, and transfer roller 10 configured to perform the transfer process. Fuser unit 13 includes cylindrical heat roller 11, halogen lamp 11a, and backup roller 12 serving as an elastic roller. Heat roller 11 is formed by coating the surface of a simple aluminum pipe with such coating materials as PFA (perfluoroalkoxyalkane) and PTFE (polytetrafluoroethylene). Halogen lamp 11a is provided in heat roller 11, and serves as a heat source. Heat roller 11 and backup roller 12 are pressed against each other.

Heat roller 11 is rotated in a direction (direction G shown in FIG. 2) which is the same as the transport rotary direction A of photosensitive drum 20, by a drive power transmitted to a heat roller gear (not illustrated) via a gear train that is different from the gear train for photosensitive drum 20. Along with the rotation of heat roller 11, backup roller 12 is driven to rotate in the driven direction (direction H shown in FIG. 2). Halogen lamp 11a generates heat by using the electric power supplied from the power source unit (not illustrated). Heat roller 11 is controlled by a controller (not illustrated) so that the surface temperature of heat roller 11 can be kept at a predetermined fixing temperature. Note that the above-mentioned power source unit is an electric-power source that is commonly used as a high-voltage power source of electrophotographic printer 1.

The print operations of printer 1 with the above-described configuration are performed under the control of a controller (not illustrated), such as a CPU. On the basis of a program stored in a memory unit (not illustrated), such as a memory and a magnetic disc, the controller controls the power source unit, the drive source, and the like. Thereby, the controller controls the operations in the exposure process performed by exposure head 9, those in the development process performed by the rollers and the like in development device 7, those in the transfer process performed by transfer roller 10, and those in the fixing process performed by fuser unit 13.

Description is given below of the print operations performed by printer 1 of Embodiment 1. Once the print operations are started, in printer 1, the controller (not illustrated) sends a print command to the drive source (not illustrated), the power source unit (not illustrated), and the like. The controller makes the drive source rotate photosensitive drum 20 in transport rotary direction A by means of the gear train (not illustrated) and the drum gear (not illustrated). In addition, the controller makes the drum gear rotate charge roller 21, development roller 22, cleaning roller 23, and transfer roller 10. Moreover, the controller makes the development gear of development roller 22 rotate supply roller 25. The controller further makes a different gear train rotate heat roller 11 and backup roller 12 that is driven by the rotation of heat roller 11. In this case, each of the above-mentioned rollers rotates in the corresponding one of the directions indicated with arrows A to H in FIG. 2.

Substantially simultaneous with the start of the rotating of the rollers by the drive source, the controller makes the power source unit (not illustrated) apply preset, predetermined voltages to the rollers in development device 7, and transfer roller 10. In addition, the controller supplies, or stops supplying, the electric power to halogen lamp 11a of heat roller 11 so that the surface temperature of heat roller 11 can be kept at the predetermined fixing temperature. In Embodiment 1, a −300V supply voltage is applied to supply roller 25, whereas a −200V development voltage is applied to development roller 22.

The charge voltage applied to charge roller 21 and the rotation of charge roller 21 uniformly charge the surface of photosensitive drum 20 (at −600V in Embodiment 1). When the charged area of photosensitive drum 20 reaches a position under exposure head 9, the controller makes exposure head 9 emit light in accordance with data on the image to be printed, and thereby forms an electrostatic latent image on photosensitive drum 20.

Once the area of photosensitive drum 20 on which the electrostatic latent image is formed reaches development roller 22, the difference between the potential (−20V in Embodiment 1) of the electrostatic latent image on photosensitive drum 20 and the potential of development roller 22 makes the toner on development roller 22, which has been spread into the thin layer by development blade 24, adhere to the surface of photosensitive drum 20. Thereby, a toner image is formed on photosensitive drum 20. The toner image is transferred to paper sheet P by the transfer voltage applied to transfer roller 10. The transferred toner image is fixed to the surface of paper sheet P by both the heat generated by heat roller 11, which is heated at a predetermined temperature by halogen lamp 11a, and the pressing force exerted between heat roller 11 and backup roller 12. Paper sheet P to which the image is fixed is transported by discharge rollers 17, 18, and is thereby discharged onto stacker 16.

In the meantime, some part of the toner that is left on photosensitive drum 20 without being transferred to paper sheet P is pooled temporarily in cleaning roller 23 by a positive voltage applied to cleaning roller 23. Once the print operations are finished, part of the toner is collected into toner chamber 27 of development device 7 in accordance with a predetermined sequence performed by the controller. The print operations by printer 1 of Embodiment 1 are performed in this way.

Along with the recent trend of faster printing and higher-resolution printing, toners each with a smaller particle size, which is 7 μm or less on average, have come in use as toners to produce high-resolution images. It is expected that toners will be produced in yet smaller particle sizes in the future. The progressively smaller particle sizes may cause a phenomenon in which: as particle sizes of toners become smaller, the reduction of the van der Waals'force reduces the adherence among toner particles; the reduced adherence decreases the amount of toner adhering to the surface of development roller 22; the decreased amount of adhering toner makes the thin layer of toner become thinner to impair the coloring ability; and the print density of the toner image accordingly becomes lower than the set-up density.

Incidentally, a carbon black, such as furnace black and channel black, is usually used as the colorant in the case of black color. If the amount of the carbon black is increased to compensate for the poor print density caused by the smaller particle size of the toner, the carbon black, which is electrically conductive, affects the electric properties and frictional chargeability of the toner depending on what kind of carbon black is used and how much. The ability of toner particles to keep the electrical charges is lowered which makes the amount of charges unstable. Hence, such inconveniences as lower print density, faded print, drum fog, and smearing of print take place, and consequently, obtaining stable print quality becomes difficult.

Embodiment 1 aims to suppress such inconveniences as the lowering of the ability of toner particles to keep the electrical charges, which are caused by the conductivity of the carbon black, by using a charge control agent in black (referred to as a “black charge control agent”). At the same time, Embodiment 1 aims to improve the color formation in a black toner image. A complex of metal-containing azo compound containing such metals as iron, cobalt, chromium, zinc or the like can be used as the black charge control agent. Note that the colors of the metal containing azo compounds containing the above-mentioned metals include a color that is not “black” in a strict sense, but rather is, e.g., a very dark violet. In Embodiment 1, however, if an ordinary person recognizes, by his or her vision, that a color is “black,” the charge control agent in such a color is referred to as the black charge control agent.

The smaller-particle toner of Embodiment 1 is produced by using: polyester resin (glass-transition temperature Tg=62° C., softening temperature T_{1/2}=115° C.) as the binder resin; an iron-based azo compound, specifically, T-77 (manufactured by Hodogaya Chemical Co., Ltd.) as the black charge control agent; a carbon black with an average particle size of 30 nm (specifically, MOGUL-L manufactured by Cabot Corporation) as the colorant; and a carnauba wax (specifically, Powdered Carnauba Wax No. 1 manufactured by S. Kato & Co.) used as a release agent.

The above-mentioned ingredients of the toner are mixed together with their respective blending quantities, which are to be specified later. Then, the mixture is mixed by using a Henschel mixer. After that, the resultant mixture is melted and kneaded by using a twin-screw extruder. Then, the kneaded mixture is cooled, and is then cracked roughly by using a cutter mill with a screen of a 2 mm diameter. After that, an impact type grinder, specifically Dispersion Separator (manufactured by Nippon Pneumatic Mfg. Co., Ltd.), is used for grinding the roughly-cracked pieces. Then, the particles thus obtained are classified by using a wind-force classifier. Thus obtained are toner mother particles with a mean volume diameter of 7.0 μm. The toner thus obtained is negatively chargeable.

The mean volume diameter of the toner mother particles thus obtained is found by measurement using a cell counting analyzer, specifically Coulter Multisizer 3 (manufactured by Beckman Coulter Inc.). The measurement is conducted with an aperture diameter of 100 μm and the particles are measured up to 30000 counts.

The circularity of the toner mother particles is found by using a flow particle image analyzer, specifically, FPIA-2100 (manufactured by Sysmex Corporation). The circularity of the toner mother particles is 0.9. Circularity is obtained by the following equation:

Circularity=L1/L2 (1)

where L1 is the length of the circumference of a circle whose area is equal to the area of the projected image of each toner mother particle, and L2 is the length of the perimeter of the projected image of each particle. A circularity of 1.00 means that the particle is shaped like a complete sphere. As the circularity becomes increasingly smaller than 1.00, the shape of the particle becomes more indeterminate.

In Embodiment 1, for the purpose of finding blending quantities of the carbon black and the black charge control agent to stabilize the chargeability of the toner and to obtain a satisfactory print quality, a total of 49 types of toner mother particles are formed by: using 4 parts by weight of Carnauba Wax against 100 parts by weight of the binder resin; and combining each of 7 levels set at 0.1, 0.3, 0.6, 0.9, 1.2, 1.3, and 1.5 parts by weight of the black charge control agent, with each of 7 levels set at 2.0, 3.0, 4.0, 5.0, 6.0, 7.0, and 8.0 parts by weight of the carbon black.

Subsequently, for each type of toner mother particles, a sample toner for an evaluation test is obtained by: adding 0.2 parts by weight of MP-1000 (Soken Chemical and Engineering Co., Ltd.) and 1.8 parts by weight of Aerosil RX50 (Nippon Aerosil Co., Ltd.), as external additives, to 100 parts by weight of the toner mother particles; and blending the thus-obtained mixture for 25 minutes. The evaluation test is achieved by: conducting a print test in a manner described below; evaluating the print density, smearing of print, and drum fog which occur during the print test; and determining a range of the blending quantity of the carbon black and a range of the blending quantity of the black charge control agent, from which a best print quality can be obtained, by putting all the measurement results together.

For each of the 49 different types of sample toners obtained by changing the amount of the carbon black and the amount of the black charge control agent, the print test is achieved by: storing the type of sample carbon in toner cartridge 26 of development device 7 of printer 1 described above; printing an image on 1000 letter-sized standard paper sheets (Xerox 4200, whiteness of 92, basis weight=20Lb) with a 1-percent duty (100% duty means that a solid print is performed on 100% of the printable area) while feeding each letter-sized standard paper sheet lengthwise (i.e., the longitudinal direction of the sheet is set as the transport direction); thereafter printing a PQ (Print Quality) measurement pattern on one paper sheet; and thereby evaluating the print density, and the smearing of print on the basis of a result of the printing of the PQ measurement pattern.

After the printing of the PQ measurement pattern, the drum fog is evaluated by: stopping the white printing by turning off the power source of printer 1 while the white printing is being performed on one paper sheet with a O-percent duty; and checking the amount of toner that adheres to the surface of photosensitive drum 20. Note that the PQ measurement pattern includes: a 100% solid-pattern in an area of 0 mm to 30 mm from the top of the sheet; a 50% halftone in an area of 100 mm to 150 mm from the top of the sheet; four 100% solid-block points, each of which has of a 1 mm² area, located respectively in the four corners of the sheet each at a position 50 mm away from the top or bottom of the sheet and 50 mm away from the right or left side of the sheet; and a 100% solid-block point of a 1 mm² area located at a position 180 mm away from the top of the sheet and 90 mm away from the right-hand side of the sheet.

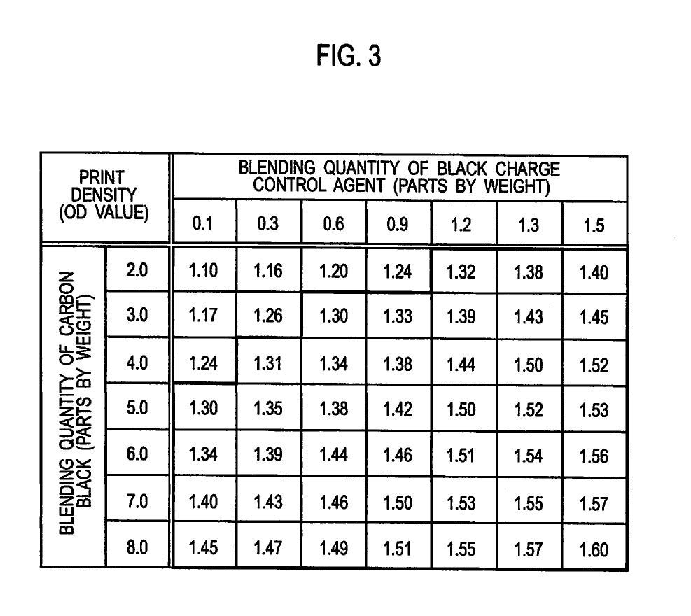

To measure the print density, the density of each of the five 100% solid-block points each with the 1 mm² area in the PQ measurement pattern is measured by using a spectrophotometric colorimeter, specifically, X-Rite 528 (manufactured by Canon i-tech, Inc.). The average value of the five OD (Optical Density) values thus obtained is used as the value corresponding to the print density. The measurement results of the print density are shown in FIG. 3.

In this respect, the OD value is a value corresponding to the reflectivity obtained by casting light on an object (specifically, each 100% solid block in Embodiment 1). To be more specific, the OD value=−log(reflectivity). A smaller reflectivity makes the OD value larger. Hence, in Embodiment 1, a more blackish block absorbs more casted light, thus resulting in a smaller reflectivity and a larger OD value.

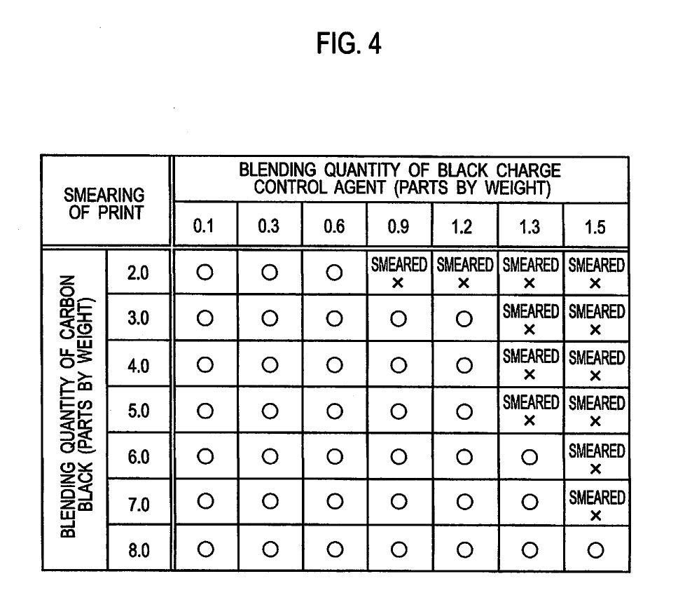

As FIG. 3 shows, the print density tends to become higher as the blending quantity becomes larger. Hence, it can be learned from this tendency that not only the blending quantity of the carbon black but also the blending quantity of the black charge control agent are effective in adjusting the print density. To determine whether or not each measurement result means the print density is satisfactory, an OD value of 1.30 is used as the threshold. That is, if the OD value is equal to 1.30 or greater, the print density is judged to be satisfactory (the area surrounded by thick solid lines in FIG. 3). A criteria for evaluating the smearing of print is whether or not toner is unintentionally printed in the 0% duty portion of the PQ measurement pattern, that is to say, in the background-color portion. That is, it is judged whether or not an unintentionally printed toner exists. FIG. 4 shows the results of a judgment concerning the smearing of print.

As FIG. 4 shows, the smearing of print tends to become less likely to happen as the blending quantity of the carbon black increases, and to become more likely to happen as the blending quantity of the black charge control agent increases. It can be learned from this tendency that an increase in the blending quantity of the black charge control agent leads to excessive charging, whereas an increase in the blending quantity of the carbon black leads to undercharging. Note that, as a result of each judgment, symbol “x” is used for the case where smearing of print takes place whereas symbol “o” is used for the case where no smearing of print takes place. Note that smearing of print is defined as a state in which a toner adheres to the background of the image, namely, the non-image portion of the sheet when the amount of charge in the toner is high compared with the normally-charged toner, that is to say, when the toner is what is termed as an overcharged toner. The overcharged toner that causes the smearing of print is referred to as smearing toner.

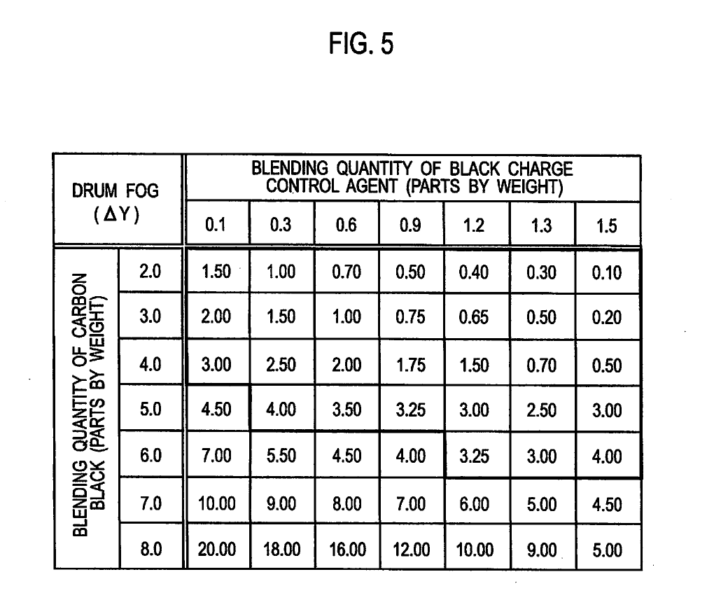

The measurement of the drum fog is achieved by: detaching development device 7 from printer 1 after the above-mentioned stopping of the printing; causing the toner existing on photosensitive drum 20 after the development but before the transfer to adhere to a piece of transparent adhesive tape (Scotch Mending Tape manufactured by Sumitomo 3M Ltd.); and applying the piece of the tape to a white mat board (the tape is referred to as a “piece of fog-collection tape”). For comparative purposes, a piece of unused adhesive tape that has never been applied to photosensitive drum 20 is applied to the same mat board (the tape is referred to as a “piece of comparative tape”). The color difference ΔY of the piece of fog-collection tape from the piece of comparative tape is measured by a spectrophotometric colorimeter (CM-2600d manufactured by Konica Minolta Inc.; measurement diameter=φ8 mm). The average value of the color difference ΔY is used as a value corresponding to the drum fog. FIG. 5 shows results of the measurement concerning the drum fog (each value shown in FIG. 5 is an average value of ΔY).

Note that the color difference (L*a*b* color-system chromaticity) ΔY is calculated by the following equation:

ΔY=−(ΔL*²+Δa*²+Δb*²)^{1/2} (2),

where L* is brightness; a*and b* are chromatic coordinates in the color space (JISZ87291).

As FIG. 5 shows, the drum fog tends to become more likely to occur as the blending quantity of the carbon black increases, and to become less likely to occur as the blending quantity of the black charge control agent increases. It can be learned from this tendency that an increase in the blending quantity of the carbon black leads to an increase in the undercharged toner, while an increase in the blending quantity of the black charge control agent leads to the overcharging. To determine whether or not each measurement result means the occurrence of the drum fog, the color difference ΔY of 4.00 is used as the threshold. A color difference ΔY that is equal to 4.00 or less means a favorable printing (the area surrounded by thick solid lines in FIG. 5). A color difference ΔY that is larger than 4.00 means an often repeated occurrence of the drum fog.

Note that the drum fog is defined as a state in which a toner adheres to the background portion of the image, namely, the non-image portion of the sheet when the amount of charge in the toner is lower, or the polarity of the charge of the toner is opposite, compared with the normally-charged toner. The toner with a lower charged amount, or the toner charged in an opposite polarity, is referred to as the fog toner.

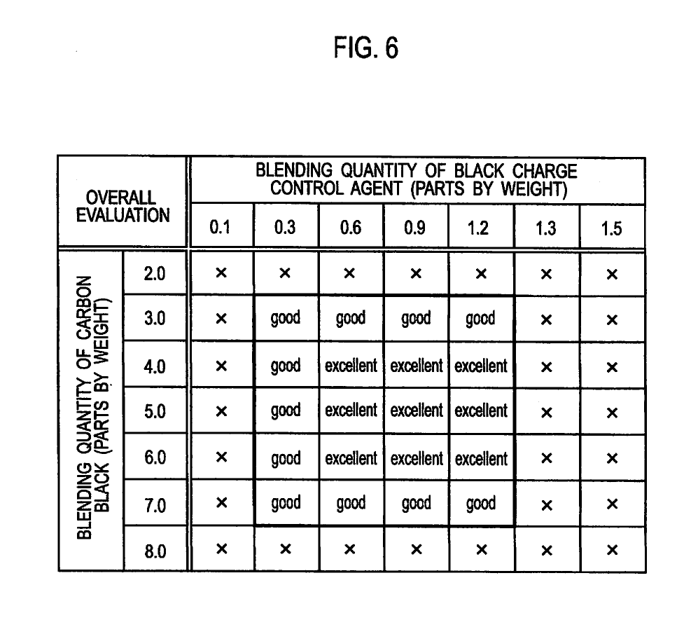

FIG. 6 shows the results of an overall evaluation based on the above-described measurement results and the judgment results. For the judgment concerning the overall evaluation, if a toner achieves an OD value of the print density of 1.30 or greater, and a color difference ΔY of the drum fog of 4.00 or less, as well as causes no smearing of print, the printing using the toner is evaluated as very satisfactory, and is defined and shown in Figures as “excellent.” If a toner achieves an OD value of the print density of 1.20 to 1.30, or a color difference ΔY of the drum fog of 4.00 to 9.00, the toner is evaluated as suitable for practical use although inferior to the toner evaluated as “excellent,” and is defined and shown in Figures as “good.”

From the results of the overall evaluation, we learn the following: (1) The toner in which the blending quantity of the carbon black is 3.0 to 7.0 parts by weight, and the blending quantity of the black charge control agent is 0.3 to 1.2 parts by weight, is suitable for practical use (the area surrounded by the thick solid line in FIG. 6). (2) A better print quality can be obtained from the use of a toner in which the blending quantity of the carbon black is 4.0 to 6.0 parts by weight and the blending quantity of the black charge control agent is 0.6 to 1.2 parts by weight.

In this manner, because the blending quantity of the carbon black and the blending quantity of the black charge control agent are made to fall within their respective appropriate ranges, the toner of Embodiment 1 can secure the stable print density, while at the same time inhibit the occurrence of the smearing of print and the drum fog and, accordingly, offer a better print quality, even where the carbon black is used as the colorant for the small-particle toner.

As described above, because the blending quantity of the carbon black is set in the range of 3.0 to 7.0 parts by weight and the blending quantity of the black charge control agent is set in the range of 0.3 to 1.2 parts by weight when the black charge control agent is used as the charge control agent for the black toner with a mean particle size of 7 μm or less, and the 100 parts by weight of the binder resin is used, Embodiment 1 can secure a stable print density, can concurrently inhibit the occurrence of the smearing of print and the drum fog, and accordingly, offers a better print quality, even when the carbon black is used as the colorant for the small-particle toner.

Note that it suffices if the average particle size of the carbon black falls within a range of 20 nm to 50 nm, although the description of Embodiment 1 is based on the assumption that the average particle size of the carbon black is 30 nm. The use of a carbon black with an average particle size of not less than 20 nm produces a bluish printed image that would otherwise be a black printed image. The use of a carbon black with an average particle size of not greater than 50 nm produces a reddish printed image that would otherwise be a black printed image.

### Embodiment 2

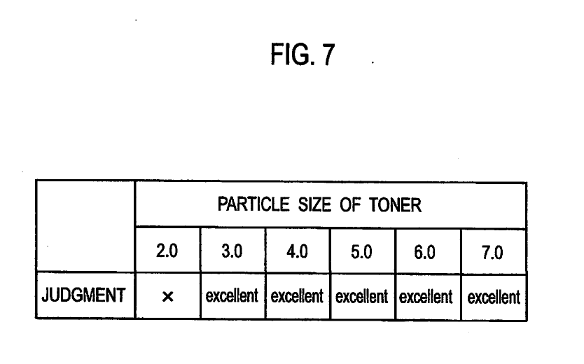

Description is given of a developer of Embodiment 2 by referring to FIG. 7. Those portions in Embodiment 2 that are identical to their respective counterparts in Embodiment 1 are denoted by the same reference numerals as used in Embodiment 1. No description for such portions is provided below. As described earlier in Embodiment 1, a smaller-particle toner reduces the van der Waals' force, and the reduction in the van der Waals' force reduces the adherence among toner particles. Hence, the amount of toner adhering to the surface of development roller 22 becomes smaller. This causes the print density of the toner image to become lower. In Embodiment 2, an evaluation is conducted on the prints produced with toners whose respective particle sizes are even smaller than the 7 μm particle size of the sample toners used in Embodiment 1.

An evaluation test is conducted by measuring the print density of the PQ measurement pattern and the drum fog as in Embodiment 1 for each of 6 types of sample toners. The particle sizes of the 6 toner types are set at 6 levels including 2.0, 3.0, 4.0, 5.0, 6.0, and 7.0 μm, respectively. For each of the 6 settings, the blending quantity of the carbon black is 4.0 parts by weight and the blending quantity of the black charge control agent is 0.9 parts by weight, against 100 parts by weight of the binder resin. Overall evaluation results are obtained as shown in FIG. 7. Note that other factors, such as the blending quantity of the Carnauba Wax and the blending quantity of the external additive, are equal to those in the case of Embodiment 1.

As FIG. 7 shows, the overall evaluation for each of the toners with a particle size in a range of 3.0 μm to 7.0 μm is “excellent.” Note that overall evaluation similar to those shown in FIG. 7 are obtained from toners in each of which the blending quantity of the carbon black is in the range of 4.0 to 6.0 parts by weight, and the blending quantity of the black charge control agent is in the range of 0.6 to 1.2 parts by weight, against 100 parts by weight of the binder resin.

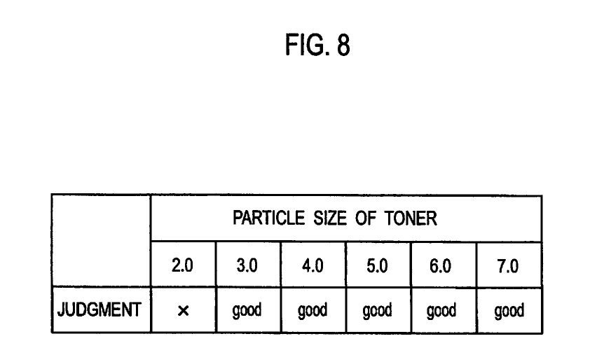

In addition, the print density and the drum fog are measured in a manner similar to that described above with the blending quantity of the carbon black set at 3.0 parts by weight and the blending quantity of the black charge control agent set at 0.3 parts by weight, against 100 parts by weight of the binder resin. The results obtained of an overall evaluation are as shown in FIG. 8. As FIG. 8 shows, the overall evaluation of each of the toners with a particle size in a range of 3.0 μm to 7.0 μm is “good.”

Note that overall evaluation results similar to those shown in FIG. 8 are obtained from toners in each of which the blending quantity of the carbon black is 3.0 parts by weight, and the blending quantity of the black charge control agent is in a range of 0.3 to 1.2 parts by weight, against 100 parts by weight of the binder resin. In addition, overall evaluation similar to those shown in FIG. 8 are obtained from toners in each of which the blending quantity of the carbon black is 7.0 parts by weight, and the blending quantity of the black charge control agent is in a range of 0.3 to 1.2 parts by weight, against 100 parts by weight of the binder resin. Overall evaluation results are obtained similar to those shown in FIG. 8 as well from toners in each of which the blending quantity of the carbon black is in a range of 4.0 to 6.0 parts by weight, and the blending quantity of the black charge control agent is 0.3 parts by weight, against 100 parts by weight of the binder resin.

As described above, in the case of the black toner in which the average particle size of the toner particles is 3.0 μm to 7.0 μm, it is possible to secure the stable print density and, at the same time, to inhibit the occurrence of the smearing of print and the drum fog so to obtain the better print quality if the blending quantity of the carbon black is set in a range of 3.0 to 7.0 parts by weight, and the blending quantity of the black charge control agent is set in a range of not smaller than 0.3 parts by weight but not greater than 1.2 parts by weight, against the 100 parts by weight of the binder resin.

Furthermore, in the case of a black toner in which the average particle size of the toner particles is 3.0 μm to 7.0 μm, it is possible to obtained a much better print quality if the blending quantity of the carbon black is set in a range of 4.0 to 6.0 parts by weight and the blending quantity of the black charge control agent is set in a range of 0.6 to 1.2 parts by weight, against 100 parts by weight of the binder resin.

Note that, although each of Embodiments 1 and 2 is described on the assumption that the image formation apparatus is an electrophotographic monochrome printer, the image formation apparatus may be other types of apparatuses, such as an electrophotographic color printer, facsimile machine, photocopier, or an MFP (multi-function printer).

The invention includes other embodiments in addition to the above-described embodiments without departing from the spirit of the invention. The embodiments are to be considered in all respects as illustrative, and not restrictive. The scope of the invention is indicated by the appended claims rather than by the foregoing description. Hence, all configurations, including the meaning and range within equivalent arrangements of the claims, are intended to be embraced in the invention.

What is claimed is:

1. A developer comprising:
a binder resin;
a carbon black; and
a black charge control agent, wherein
when an amount of the binder resin is 100 parts by weight, a blending quantity of the carbon black is set in a range of 3.0 to 7.0 parts by weight, both inclusive, and a blending quantity of the black charge control agent is set in a range of 0.3 to 1.2 parts by weight, both inclusive.

2. The developer according to claim 1, wherein the carbon black has an average particle size of 20 nm to 50 nm, both inclusive.

3. The developer according to claim 1, wherein the black charge control agent is a metal azo compound.

4. The developer according to claim 1, wherein the black charge control agent is a metal azo compound containing iron.

5. The developer according to claim 1, wherein the black charge control agent is a metal azo compound containing at least one of iron, cobalt, chromium, and zinc.

6. The developer according to claim 1, wherein the developer has an average particle size of 3.0 μm to 7.0 μm, both inclusive.

7. The developer according to claim 1, wherein
the blending quantity of the carbon black is set within a range of 4.0 to 6.0 parts by weight, both inclusive, and the blending quantity of the black charge control agent is set within a range of 0.6 to 1.2 parts by weight, both inclusive.

8. The developer according to claim 7, wherein the developer comprises an average particle size of 3.0 μm to 7.0 μm, both inclusive.

9. The developer according to claim 1, wherein the developer is negatively chargeable.

10. A development device comprising:
a developer stocker configured to store the developer of claim 1; and
a developer carrier configured to carry the developer on a surface of the developer carrier.

11. The development device according to claim 10, further comprising a supply member configured to supply the developer to the developer carrier.

12. The development device according to claim 11, wherein the developer carrier and the supply member are in pressure contact with each other.

13. The development device according to claim 12, wherein the supply member is pressed into the developer carrier by a distance of 0.85 mm to 1.15 mm, both inclusive.

14. An image formation apparatus comprising:
the development device of claim 10;
a medium stocker configured to store a medium;
a medium stacker; and
a medium transporter configured to transport the medium from the medium stocker through the development device and discharge the medium to the medium stacker.
